(19) United States
(12) Patent Application Publication
(10) Pub. No.: US 2013/0171405 A1
(43) Pub. Date: Jul. 4, 2013

(54) PARTICLE ENHANCED COMPOSITION FOR WHISKER MITIGATION

(71) Applicants: Stephan John Meschter, Endicott, NY (US); Stephen Arthur McKeown, Endicott, NY (US)

(72) Inventors: Stephan John Meschter, Endicott, NY (US); Stephen Arthur McKeown, Endicott, NY (US)

(73) Assignee: BAE SYSTEMS CONTROLS INC., Johnson City, NY (US)

(21) Appl. No.: 13/338,844

(22) Filed: Dec. 28, 2011

(51) Int. Cl. B32B 1/04; B32B 15/04; H01B 1/02

(52) U.S. Cl. 428/76; 252/512; 252/514; 428/457; 428/469

(57) ABSTRACT

A method of obstructing metal whisker growth that includes providing a conductive structure comprised of a whisker forming metal, and forming a composite coating on the whisker forming metal. The composite coating may include a matrix phase of a polymer and a dispersed phase of reinforcing particles. The reinforcing particles are incorporated into the polymer to provide the composite coating with mechanical properties that obstruct whiskers from penetrating through the composite coating.

### BACKGROUND

The present disclosure is related to mitigating the effects of whisker formation and growth in conductive metals.

Whiskers are electrically conductive, crystalline structures of metal that sometimes grow from metal surfaces (especially electroplated tin). Tin whiskers have been observed to grow to lengths of several millimeters (mm) and in rare instances to lengths in excess of 10 mm. Numerous electronic system failures have been attributed to short circuits caused by whiskers that bridge closely-spaced circuit elements maintained at different electrical potentials.

### SUMMARY

In one aspect, the present disclosure provides a composite coating for mitigating the effects of whisker growth from the metal surfaces of a conductive structure. In one embodiment, a structure is provided that includes a whisker forming metal, and a composite coating comprising a matrix phase of a polymer and a dispersed phase of reinforcing particles. The composite coating encapsulates at least a portion of the whisker forming metal. The reinforcing particles within the matrix phase of polymer produces a composite coating having mechanical properties that obstruct whiskers from protruding through the composite coating.

In another aspect, the present disclosure provides a method of mitigating the effects of whisker growth in conductive structures. In one embodiment, the method of obstructing metal whisker growth includes providing a structure composed of a whisker forming metal, and forming a composite coating on the whisker forming metal. The composite coating includes a matrix phase of a polymer and a dispersed phase of reinforcing particles. The reinforcing particles are incorporated into the polymer to obstruct whiskers produced by the whisker forming metal from penetrating through the composite coating.

In another aspect, a method of obstructing electrical shorting is provided that includes providing a conductive structure adjacent to a whisker forming material, and forming a composite coating on the conductive structure. The composite coating includes a matrix phase of a polymer and a dispersed phase of reinforcing particles. The reinforcing particles are incorporated into the polymer to obstruct whiskers that are produced by the whisker forming metal from penetrating through the composite coating into contact with the conductive structure.

In yet another aspect, a conductive structure is provided that includes a conductive metal, and a whisker forming material adjacent to the conductive metal, wherein a composite coating is present on the conductive metal. The composite coating includes a matrix phase of a polymer and a dispersed phase of reinforcing particles. The composite coating has a hardness ranging from 25 Shore A to 100 Shore D. The reinforcing particles within the matrix phase of the polymer obstructs whiskers produced by the adjacent whisker forming material from protruding through the composite coating and shorting the conductive metal to the whisker forming material.

### BRIEF DESCRIPTION OF THE DRAWINGS

The following detailed description, given by way of example and not intended to limit the disclosure solely thereto, will best be appreciated in conjunction with the accompanying drawings, wherein like reference numerals denote like elements and parts, in which:

FIG. 1 is a side cross-sectional view depicting a conductive structure composed of a whisker forming metal having a composite coating present thereon, wherein the composite coating includes reinforcing particles that increase the mechanical properties of the composite coating in order to obstruct whisker penetration, in accordance with one embodiment of the present disclosure.

FIG. 2A is a magnified cross-sectional view of one embodiment of the composite coating depicted in FIG. 1, wherein the composite coating includes a polymer matrix and reinforcing particles having a sphere like geometry, in accordance with the present disclosure.

FIG. 2B is a magnified cross-sectional view of one embodiment of the composite coating depicted in FIG. 1, wherein the composite coating includes a polymer matrix and reinforcing particles having a fiber like geometry, in accordance with the present disclosure.

FIG. 2C is a magnified cross-sectional view of one embodiment of the composite coating depicted in FIG. 1, wherein the composite coating includes a polymer matrix and reinforcing particles having a plate like geometry, in accordance with the present disclosure.

FIG. 3 is side cross-sectional view of a whisker growing from the whisker forming metal of the conductive structure depicted in FIG. 1, wherein the buckling force of the whisker is greater than the rupture force of the composite coating, in accordance with one embodiment of the present disclosure.

FIG. 4A is a side cross-sectional view depicting buckling of the whisker growing from the whisker forming metal, wherein the buckling force of the whisker is less than the symmetrical rupture force of the composite coating, in accordance with one embodiment of the present disclosure.

FIG. 4B is a side cross-sectional view depicting bending of the whisker growing from the whisker forming metal, wherein the buckling force of the whisker is less than the asymmetrical force of the composite coating prior to coating rupture, in accordance with one embodiment of the present disclosure.

FIG. 5A is a perspective view of forming a non-conformal composite coating on the surface of a whisker forming metal having a polyhedron geometry, in accordance with one embodiment of the present disclosure.

FIG. 5B is a magnified side cross-sectional view of the non-conformal composite coating at a corner surface of the conductive structure depicted in FIG. 5A, in which the concentration of the reinforcing particles is greater at the corner surface of the conductive structure than at the face surfaces of the conductive structure, in accordance with the present disclosure.

FIG. 6A is a side cross-sectional view depicting a conductive structure composed of a whisker forming metal having a composite coating present thereon, wherein an interface layer of an unfilled polymer having a higher elasticity than the composite coating is present between the composite coating and the conductive structure, in accordance with the present disclosure.

FIG. 6B is a side cross-sectional view depicting a conductive structure composed of a whisker forming metal having a composite coating present thereon, wherein an interface layer of a reinforced polymer having a higher elasticity than the composite coating is present between the composite coating and the conductive structure, in accordance with the present disclosure.

FIG. 7 is a side cross-sectional view depicting a conductive structure having a composite coating present thereon, wherein the composite coating includes reinforcing particles that increase the mechanical properties of the composite coating in order to obstruct whisker penetration by an adjacent whisker forming material, in accordance with one embodiment of the present disclosure.

FIG. 8 is a is a side cross-sectional view depicting buckling of a whisker growing from an adjacent whisker forming material as it attempts to penetrate the composite coating, in accordance with one embodiment of the present disclosure.

### DETAILED DESCRIPTION

Detailed embodiments of the claimed structures and methods are disclosed herein; however, it is to be understood that the disclosed embodiments are merely illustrative of the claimed structures and methods that may be embodied in various forms. In addition, each of the examples given in connection with the various embodiments are intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper”, “lower”, “right”, “left”, “vertical”, “horizontal”, “top”, “bottom”, and derivatives thereof shall relate to the disclosed embodiments, as they are oriented in the drawing figures. The terms “on”, “overlying”, “atop”, “positioned on” or “positioned atop” means that a first element, such as a first structure, is present on a second element, such as a second structure, wherein intervening elements, such as an interface structure, e.g. interface layer, may be present between the first element and the second element. The terms “directly on”, “direct contact” means that a first element, such as a first structure, and a second element, such as a second structure, are connected without any intermediary conducting, insulating or semiconductor layers at the interface of the two elements.

The present disclosure relates to using a composite coating that can be applied to a surface of a conductive structure including a whisker forming metal, wherein the mechanical properties of the composite coating obstructs whiskers produced by the whisker forming metal from penetrating through the composite coating. As used herein, the term “mechanical properties” means that at least one of the hardness, peel force and rupture force of the composite coating is sufficient to obstruct whiskers from penetrating the composite coating. In some embodiments, by obstructing the whisker forming metal from having whiskers penetrating through the composite coating, the methods and structures disclosed herein reduces the incidence of shorting between adjacent electrically conductive structures through bridging whiskers.

As used herein, the term “whisker” denotes an electrically conductive, crystalline structure of metal that grows from a metal surface. A whisker is a needle like structure (also referred to as a filament) that grows outward from the metal surface. A “whisker forming metal” is a metal that forms metal whiskers. One example of a whisker forming metal is tin. Tin whiskers have been observed to grow to lengths of several millimeters (mm) and in some instances can grow to lengths in excess of 10 mm. Tin is only one of several metals that are known to be capable of growing whiskers. Other examples of metals that may form whiskers include tin (Sn), zinc (Zn), silver (Ag), gold (Au), cadmium (Cd), aluminum (Al), lead (Pb), indium (In), and alloys thereof, which may or may not include tin. Some theories suggest that whiskers grow in response to a mechanism of stress relief (especially “compressive” stress) within a whisker forming metal. Other theories contend that growth may be attributable to recrystallization and abnormal grain growth processes affecting the grain structure which may, or may not, be affected by residual stress in the whisker forming metal. When the whisker forming metal is electroplated, the whisker formation may result from residual stresses within the plating caused by factors, such as the plating chemistry and process.

Another cause for whisker growth may be the formation of intermetallics. For example, diffusion of a substrate material into a plating material (or vice versa) can lead to formation of intermetallic compounds that alter the lattice spacing of the plating material. The change in lattice spacing may impart stresses to the plating that may be relieved through the formation of whiskers. An even further cause for producing whiskers may be an externally applied compressive stress. For example, a compressive stress may be applied by torquing of a nut or a screw or clamp against a coated surface, which may produce regions of whisker growth. Whisker growth may also result from bending or stretching of the surface after plating. Scratches or nicks introduced to the plating of the whisker forming metal and/or the substrate material may also propagate whisker growth. In some embodiments, whisker growth may result from a difference in the coefficient of thermal expansion between the plating material of the whisker forming material and the substrate on which the whisker forming material is being deposited.

In addition to whisker growth on plating, whiskers have also been observed on solder joints containing whisker prone metals. The whisker growth may result from mechanical stresses during thermal cycling due to differences in coefficients in thermal expansion of the various parts, such as between the lead and the solder. In some embodiments, whisker growth may be from oxidation or corrosion of the solder surface and grain boundaries. Furthermore, some embodiments may exhibit whisker growth due to intermetallic and solder recrystallization.

The formation of whiskers on electrical structures may reduce the reliability of the electrical structures that include the whisker forming metal. There have been whisker-induced failures in medical devices, weapon systems, power plants, aerospace and consumer products. Typically, electric device failure resulting from whisker growth occurs when a whisker grows from a first surface through which current is flowing to a second electrically conductive surface, which causes a short in an electric circuit. One example of electrical device failure that can result from whisker formation is stable short circuits in low voltage, high impedance circuits. In such circuits there may be insufficient current available to fuse the whisker open and a stable short circuit results. Depending on a variety of factors including the diameter and length of the whisker, it can take more than 50 milliamps (mA) to fuse open a tin whisker. Another example of an electrical device failure that can result from whisker formation is transient short circuits, in which at atmospheric pressure, if the available current exceeds the fusing current of the whisker, the circuit may only experience a transient glitch as the whisker fuses open.

Another form of electrical device failure that results from whisker formation is metal vapor arc shorting. For example, if a tin whisker initiates a short during an application of high levels of current and voltage, a metal vapor arc can occur. In a metal vapor arc, the solid metal whisker is vaporized into a plasma of conductive metal ions, typically having a conductivity that is greater than the solid whiskers themselves. This plasma can form an arc capable of carrying hundreds of amperes' of current. Such arcs can be sustained for long duration (several seconds) until interrupted by circuit protection devices (e.g., fuses, circuit breakers) or until other arc extinguishing processes occur. This kind of arcing is happening in the metal vapor. Whisker formation may also result in debris and contamination type failures in electrical devices. More specifically, following formation, the whiskers may break loose and bridge isolated conductors.

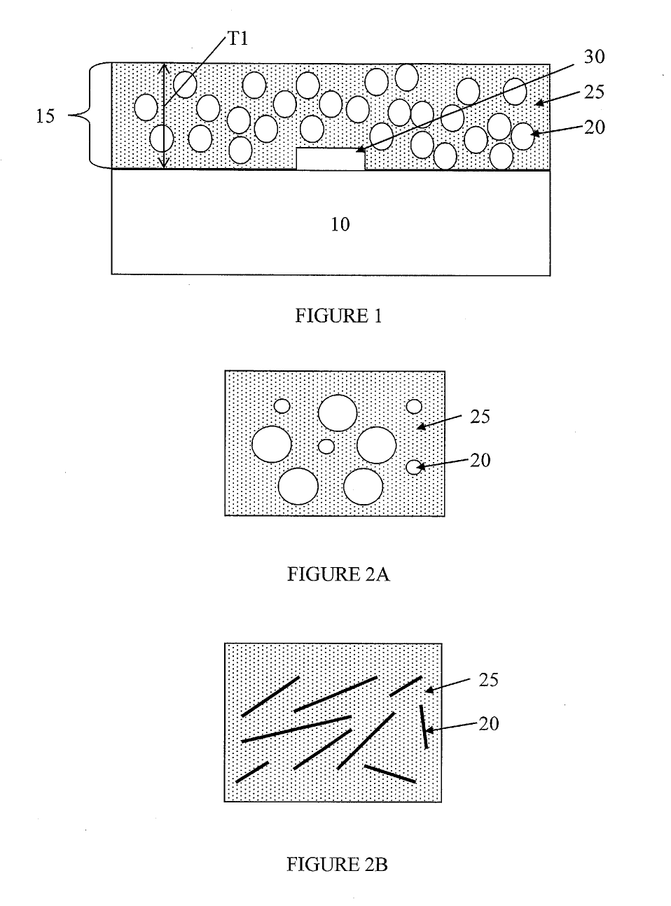

FIG. 1 depicts a conductive structure 10 composed of a whisker forming metal having a composite coating 15 present thereon, wherein the composite coating 15 includes reinforcing particles 20 that increase the mechanical properties of the composite coating 15 in order to obstruct whisker 30 from penetrating the composite coating 15. By encapsulating the whiskers 30 between the composite coating 15 and the whisker forming metal of the conductive structure 10, the methods and structures of the present disclosure may substantially reduce or eliminate whisker induced electrical device failure. In some embodiments, the composite coating 15 may be formed in direct contact with the upper surface of the conductive structure 10.

The conductive structure 10 may be any electrical device in which current may be transmitted across a portion of the electrical device that includes at least one surface composed of a whisker forming metal. For example, the conductive structure 10 may be a wire, electronic component lead, circuit board, ball grid array package, quad flat package, terminal, busbar, circuit breaker, fuse, contactor, switch, relay or a combination thereof. Other types of structures include metal enclosures, such as those use for electromagnetic shielding or mechanical protection, brackets, heatsinks, connector parts (shells, contacts or mechanical structural elements), and fasteners or a combination thereof.

The whisker forming metal present within the conductive structure 10 may include any metal that is capable of forming whiskers. In one embodiment, the whisker forming metal is a metal that is selected from the group consisting of tin (Sn), zinc (Zn), silver (Ag), gold (Au), cadmium (Cd), aluminum (Al), lead (Pb), indium (In), and alloys thereof. Some examples of metal alloys that may provide the whisker forming metal include tin alloys, such as tin-silver-copper alloys. Alloying tin with sufficient amounts of lead (Pb) may reduce whisker formation, but in some instances lead reduction within tin alloys is desired for environmental purposes. By “lead free tin alloy” it is meant that the lead content of the tin alloy is 0.0 at. %. In some embodiments, the whisker forming metal may be plating that is present on the conductive structure 10. For example, the plating may be formed on the conductive structure 10 using an electroplating process.

Referring to FIG. 1, to mitigate the effects of whisker growth, a composite coating 15 is formed on the surfaces of the conductive structure 10 that include the whisker forming metal. A composite is a material composed of two or more distinct phases, e.g., matrix phase and dispersed phase, and having bulk properties different from those of any of the constituents by themselves. As used herein, the term “matrix phase” denotes the phase of the composite that is present in a majority of the composite, and contains the dispersed phase, and shares a load with it. The matrix phase 25 may be the binder of the composite coating 15. In the present case, the matrix phase 25 may be provided by a polymer. In one embodiment, the polymer that is employed for the matrix phase 25 of the composite coating 15 is selected from the group consisting of a urethane, a polyurethane, an acrylic, an acrylated urethane, a silicone, an epoxy or a combination thereof. Specific examples of materials that are suitable for the matrix phase 25 of the composite coating 15 include polydimethylsiloxane, polyisocyanate, polyole and combinations thereof. The aforementioned polymeric materials are provided for illustrative purposes only, and are not intended to limit the present disclosure, as other polymeric materials are suitable for the matrix phase 25, so long as the polymeric material has insulating properties. For example, a polymer having a room temperature conductivity that is less than about 10⁻¹⁰(Ω-m)⁻¹ has suitable insulating properties for the matrix phase 25. Although, the following description refers to the matrix phase 25 as being a polymer, other materials may be suitable for the matrix phase of the composite coating 15.

As used herein, the term “dispersed phase” denotes a second phase (or phases) that is embedded in the matrix phase 25 of the composite coating 15. In the present case, the dispersed phase is provided by reinforcing particles 20 that increase the mechanical properties (e.g. hardness, toughness, or ultimate strength) of the composite coating 15 when compared to an unfilled coating having the same dimensions as the composite coating 15, and being composed of the same composition as the matrix phase 25 of the composite coating. The reinforcing particles 20 may be composed of an organic or non-organic material. The reinforcing particles 20 that provide the dispersed phase may be ceramic particles, such as oxides, nitrides and oxynitrides. For example, when the reinforcing particles 20 are composed of a ceramic, the ceramic composition of the reinforcing particles 20 may be selected from the group consisting of silicon oxide (SiO₂), silicon oxynitride, aluminum oxide (Al₂O₃), aluminum nitride (AlN), boron nitride (BN), silicon nitride (Si₃N₄), silicon carbide (SiC), and a combination thereof. The aforementioned ceramic materials are provided for illustrative purposes only, and are not intended to limit the present disclosure, as other ceramic materials are suitable for the reinforcing particles 20, so long as the ceramic material increases the properties of the composite coating 15 so that it is not penetrated by whiskers 30 grown from the whisker forming metal.

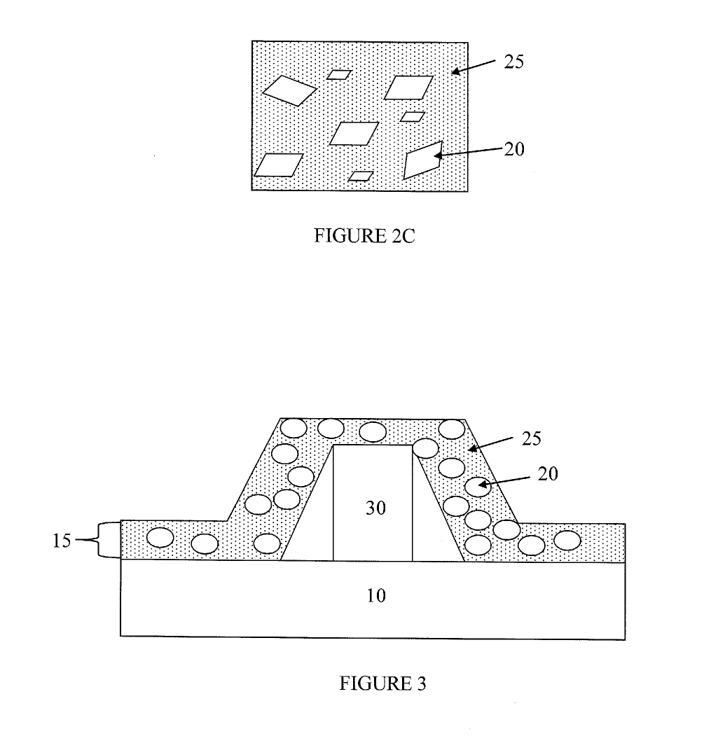

The geometry and particle size of the reinforcing particles 20 may or may not be uniform. In one embodiment, the reinforcing particles 20 may have the size of nano-particles, micro-particles or a combination of nano-particle and micro-particle sizes. As used herein, the term “nano-particle” denotes a size ranging from 10 nanometers (nm) to 50 nm, and the term “micro-particle” denotes a size ranging from 10 microns (μm) to 20 μm. In one embodiment, the reinforcing particles 20 have a particle size, as measured by the longest axis of the reinforcing particle 20, ranging from 5 nm to 50 μm. In another embodiment, the longest axis of the reinforcing particle 20 may range from 10 nm to 40 nm. In yet another embodiment, the longest axis of the reinforcing particle 20 may range from 15 μm to 35 μm. In one embodiment, the reinforcing particles 20 may have a sphere like geometry, as depicted in FIG. 2A. In another embodiment, the reinforcing particles 20 may have a fiber like geometry, as depicted in FIG. 2B. In a further embodiment, the reinforcing particles 20 may have a plate like geometry, as depicted in FIG. 2C. In yet an even further embodiment, the reinforcing particles 20 may include a mixture of geometries including sphere like, fiber like and plate like geometries. In one example, the reinforcing particles are silicon oxide (SiO₂) having a size ranging from 10 nm to 20 nm.

Still referring to FIG. 1, the concentration of the reinforcing particles 20 within the matrix phase 25 of polymer may be selected to increase the mechanical properties of the composite coating 15. Specifically, the strength, i.e., hardness and/or fracture toughness, of the composite coating is increased to obstruct the whiskers 30 from penetrating through the composite coating 15. In some embodiments, to provide sufficient strength within the composite coating 15, the concentration of reinforcing particles 20 may range from 5 percent by weight to 30 percent by weight. In one embodiment, to provide sufficient strength within the composite coating 15, the concentration of reinforcing particles 20 may range from 8 percent by weight to 12 percent by weight. The volume occupied by the reinforcing particles 20 in the composite coating 15 may range from 5% to 30%. In another embodiment, the volume occupied by the reinforcing particles 20 in the composite coating 15 may range from 10% to 20%. It is noted that the concentrations provided for the reinforcing particles 20 are for illustrative purposes and are not intended to limit the present disclosure to only the concentrations that have been disclosed. Other concentrations for the reinforcing particles 20 may be employed within the present disclosure, so long as the concentration selected provides sufficient strength to obstruct whisker penetration, and the coating composition that provides the composite coating 15 has a viscosity suitable for sufficient coverage of the conductive structure 10.

In some embodiments, prior to deposition of the composite coating 15, the polymer that provides the matrix phase 25 and the reinforcing particles 20 are intermixed by mechanical mixing to provide a solid in liquid colloidal dispersion. In some embodiments, to ensure wetting of the reinforcing particles 20 within the polymer of the matrix phase 25, the surface of the reinforcing particles 20 may be functionalized. The reinforcing particles 20 may also be functionalized to control agglomeration. For example, before mixing with the polymer that provides the matrix phase 25 and the reinforcing particles 20 that provide the dispersed phase into a coating composition for forming the composite coating 15, the reinforcing particles 20 may be functionalized with either alkoxysilane or a silane modified isocyanate.

Alkoxysilane modification of unmodified reinforcing particles 20 of nanosilica, i.e., silicon oxide (SiO₂) particles with a diameter of about 20 nm or less, may include dispersing the unmodified nanosilica particles in a polar solvent, e.g., ketone or alcohol, such as 3-methacryloxypropyltrimethoxysilane. Functionalization of the reinforcing particles 20 with a silane-modified isocyanate may include modifying the isocyanate to improve compatibility via covalently bonding the silane functionality to the monomer of the polymer that provides the matrix phase 25 of the composite coating 15. Both of the aforementioned methods of functionalizing the reinforcing particles 20 result in covalently bonding the reinforcing particles 20, i.e., silica particles, to the polymer backbone that provides the matrix phase 25.

Other additives for functionalizing the reinforcing particles 20 may include any of the additives disclosed in the following patent documents, which are incorporated herein by reference: U.S. Ser. No. 13/278,274, U.S. Publication No. 2010/0086488, U.S. Publication No. 2009/0269568, U.S. Publication No. 2009/0212587, U.S. Publication No. 2009/0163648, U.S. Publication No. 2009/0163636, U.S. Publication No. 2009/0163618, U.S. Publication No. 2009/0124727, U.S. Publication No. 2008/0119601, U.S. Publication No. 2008/0090957, U.S. Publication No. 2007/0087195, U.S. Publication No. 2006/0063155, U.S. Pat. No. 7,713,624, U.S. Pat. No. 7,344,895, U.S. Pat. No. 7,190,506, U.S. Pat. No. 6,844,394, U.S. Pat. No. 6,599,635, U.S. Pat. No. 6,413,446, U.S. Pat. No. 6,284,834, and U.S. Pat. No. 6,020,419.

Other additives that may be included to the coating composition include additives to adjust viscosity, rheology, specific gravity, pH and optical properties of the coating. It is noted that the additives describe above are provided for illustrative purposes only, and are not intended to limit the present disclosure, as other additive may be employed in preparing the coating composition. For example, surfactants, stabilizers and fillers may also be added to the coating composition as necessary.

Following preparation of the coating composition that provides the composite coating 15, the coating composition may be applied to the surface of the conductive structure 10. In some embodiments, prior to applying the coating composition to the conductive structure 10, the deposition surface of the conductive structure 10 may be treated to increase adhesion of the coating composition. In some applications, any residual water or moisture may be removed by heating the conductive structure 10. For example, to remove moisture from the deposition surface, the conductive structure 10 may be oven heated to greater than 90° C. for greater than one hour. The conductive structure 10 may also be chemical cleaned with an alcohol based cleaner. Other surface treatments that may be applied to increase the surface energy of the deposition surface. For example, the deposition surface of the conductive structure 10 may be treated with an argon/oxygen plasma or a tetrafluoromethane (CF₄) plasma.

The coating composition may be applied to the surface of the conductive structure 10 using dip coating, spray coating, curtain coating, brushing and combinations thereof. Typically, the reinforcing particles 20 improve the mechanical properties of the composite coating 15 without adversely impacting the viscosity of the coating composition during deposition in such a way that would prevent the coating composition from penetrating under small spaces within the conductive structure 10, like those under ball grid array or chip scale packages. Additionally, the coating composition may be applied through multiple applications to provide a multi-layered composite coating 15.

The multi-layer coating approach can be used to optimize coverage, as well as, the composite film mechanical properties related to whisker mitigation. Furthermore, the coverage of the conductive structure 10 with the coating composition that provides the composite coating 15 can be increased by using a vacuum enhanced dip application to force the coating composition into small spaces.

Spray deposition can be further subdivided into aerosol spraying and handheld gun spraying. Automated spraying refers to a reciprocating spray system, in which parts on a conveyor fingers or belt move directly under a reciprocating spray head that applies the coating. The spray process may incorporate curing ovens (or in the case of ultraviolet cure, cure lamps) directly after the spray area. Ultraviolet cure can also be implemented using light application immediately following the coating application.

Dip coating is a coating method that is suitable for high volume manufacturing, in which the conductive structure 10 may be immersed in a bath including the coating composition. Dip coating may be an efficient method with minimized wasted material, i.e., minimized loss of the coating composition. Dip coating also has good repeatability once properly set up and controlled. The main variables of dip coating include immersion speed, withdrawal speed, dip dwell time, and coating viscosity. Immersion speed is set to ensure that the coating can displace air around from the components as they are dipped into the bath. The dwell time is also a consideration of the dip coating process, and should be set to allow for evacuation of any air that may be trapped in the conductive structure 10 that is being dipped for coating with the composite coating. The withdrawal rate is typically set to a slower speed than immersion and at a speed that provides for the proper coating thickness as the conductive structure 10 is removed from the bath containing the coating composition.

Curtain coating is similar to dip coating, with the exception that instead of the conductive structure 10 being dipped into a bath containing the coating composition, in curtain coating the coating composition is being poured onto the conductive structure 10. In some examples, curtain coating may be automated, in which the conductive structures 10 are drawn on a belt through the coating composition that is being poured. Brushing is most often used for repair and rework applications, where the originally applied coating needs to be replaced or supplemented.

Following deposition, the coating composition that has been applied to the conductive structure 10 may be cured. In some embodiments, curing may be achieved using oven heating, furnace heating and/or lamp heating. In some embodiments, the coating composition that provides the composite coating 15 may be cured at temperatures ranging from room temperature (e.g., 20° C. to 25° C.) to 150° C. for time periods of up to 8 hours. In one example, curing may be provided by a curing temperature of 125° C. within a time period of one hour. In some embodiments, the coating composition may be cured using ultraviolet light.

Referring to FIG. 1, following curing, the thickness T1 of the composite coating 15 may be as great as 250 microns. In one embodiment, the thickness T1 of the composite coating 15 may range from 1 micron to 10 microns. In yet another embodiment, the thickness T1 of the composite coating 15 may range from 25 microns to 75 microns. In one embodiment, the composite coating 15 may be deposited to a conformal thickness across the entire deposition surface. The term “conformal” denotes a layer having some material on all surfaces.

The composite coating 15 may have a fracture toughness and hardness that obstructs penetration of the composite coating 15 by whiskers 30 produced by the whisker forming metal of the conductive structure 10. In one embodiment, the coating strength would be capable of resisting whisker forces ranging from 2 micro-newtons to 5000 micro-newtons with elongations before rupture of up to 1000 percent. In some embodiments, to obstruct the whiskers 30 from penetrating through the composite coating 15, the composite coating 15 may have a hardness that ranges from 25 Shore A to 100 Shore D. In another embodiment, the hardness of the composite coating 15 including the reinforcing particles 20 may range from 60 Shore D to 80 Shore D. In another embodiment, the hardness of the composite coating 15 including the reinforcing particles 20 may range from 30 Shore A to 80 Shore A.

In addition to having the above-mentioned characteristics, the composite coating 15 also has sufficient adhesive strength to the deposition surface of the conductive structure 10 so that the composite coating 15 is not significantly lifted off the conductive structure 10 by the whiskers 30 produced by the whisker forming metal. For example, a composite coating 15 within the present disclosure may have a peel force range of 0.2 micro-newtons per micron to 200 micro-newtons per micron. The “peel force” is the force required to separate a cured composite coating 15 from the deposition surface of the conductive structure 10 including the whisker forming metal. In one embodiment, the peel force of the composite coating 15 ranges from 30 micro-newtons per micron to 180 micro-newtons per micron. In another embodiment, the peel force of the composite coating 15 ranges from 30 micro-newtons per micron to 40 micro-newtons per micron. In some embodiments, the peel force may be measured using a modification of ASTM D33 or ASTM D1876.

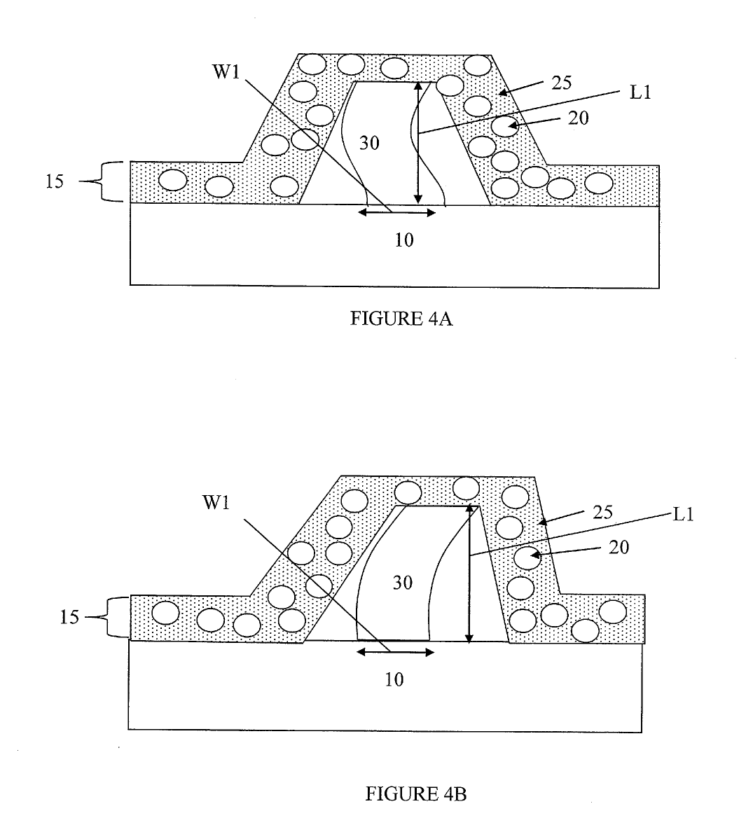

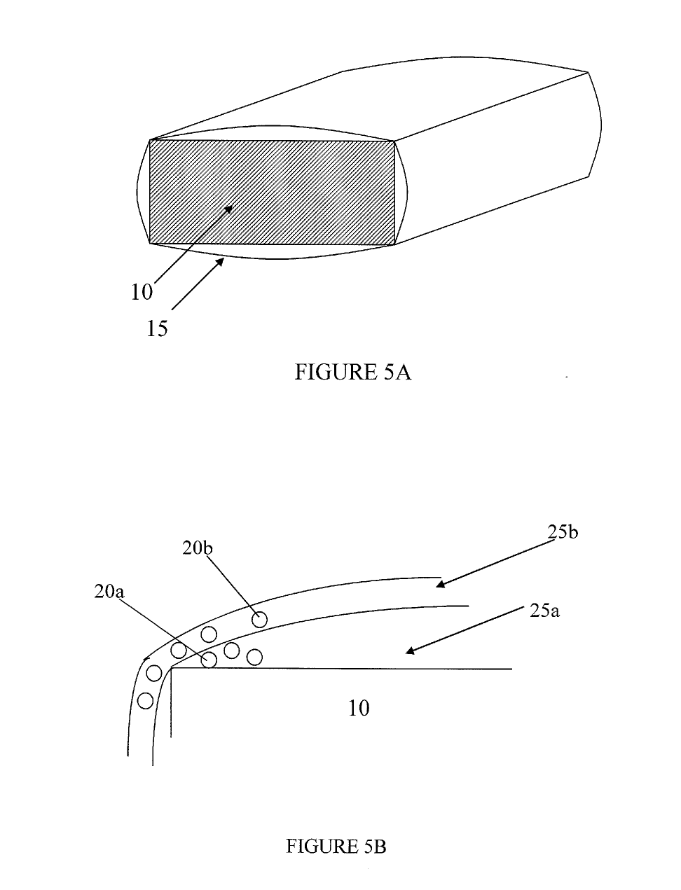

FIGS. 3-4B depict one embodiment of the present disclosure, in which the mechanical properties of the composite coating 15 obstructs whiskers 30 from protruding through the composite coating 15, and the composite coating 15 adheres to the conductive structure 10 until the buckling force of the whisker 30 is less than the rupture force of the composite coating 15. The “rupture force” is the force required for the whisker 30 penetrate through the composite coating 15. The “buckling force” of the whisker 30 is the force required to bend the whisker 30. In one embodiment, the buckling force of the whisker 30 as shown in FIG. 4B may be determined from the following formula:

P_{cr}=(π²·E·I)/(4·L²)
P_{cr}=critical buckling force
L=whisker length
I=whisker moment of inertia
E=whisker elastic modulus

FIG. 3 depicts a whisker 30 growing from the whisker forming metal of the conductive structure 10 that is depicted in FIG. 1, wherein the buckling force of the whisker 30 is greater than the peel force of the composite coating 15, and the buckling force of the whisker 30 is less than the rupture force of the composite coating 15. For example, a tin whisker 30 having a length of 77 microns and a width of 2 microns typically having a buckling force of 14 micro-newtons. In the embodiments, in which the peel force of the composite coating 15 is less than the buckling force of the whisker 30, the composite coating 15 may lift from a portion of the conductive structure 10. This phenomena may be referred to as “tenting” of the composite coating 15. The whisker 30 does not penetrate the composite coating 15, because of the mechanical properties of the composite coating 15 that at least partially results from the reinforcing particles 20.

FIGS. 4A and 4B are side cross sectional views of a whisker 30 growing from the whisker forming metal of the conductive structure 10 depicted in FIG. 3, wherein the whisker has grown to a length L1 in having a buckling force that is less than the rupture force of the composite coating 15. As the whisker 30 grows from the whisker forming metal of the conductive structure 10, the length L1 of the whisker 30 increases while the width W1 of the whisker 30 remains substantially the same. Therefore, the aspect ratio, i.e., length L1 to width W1 ratio, increases as the whisker 30 grows from the whisker forming metal. The buckling force of the whisker 30 decreases, as the whisker's aspect ratio increases. Therefore, in some instances the whisker 30 may lift a portion of the composite coating 15 off of the conductive structure 10 before the aspect ratio increases to a value that reduces the buckling force of the whisker 30 to less than the peel force of the composite coating 15. Once the buckling force of the whisker 30 decreases to be less than the rupture force of the composite coating 15 the whisker 30 deforms, and is contained encapsulated between the conductive structure 10 and the composite coating 15. Because the whisker 30 is contained, the composite coating 15 described herein reduces the incidence of whisker induced failures in electrical devices. FIG. 4A depicts buckling of the whisker 30 growing from the whisker forming metal, wherein the buckling force of the whisker is less than a symmetrical coating film force at rupture of the composite coating 15. FIG. 4B depicts buckling of the whisker 30 growing from the whisker forming metal, wherein the buckling force of the whisker 30 is less than an asymmetrical coating film force at rupture of the composite coating 15.

Referring to FIGS. 5A and 5B, in another aspect of the present disclosure, in which the reinforcing particles 20a, 20b within the composite coating are positioned at their greatest concentration at the corners, edges and tip surfaces of the conductive structure 10. It has been determined that the corners, edges and/or tip regions of the conductive structures 10 are the surfaces having the greatest probability of forming whiskers 30. By increasing the concentration of reinforcing particles 20a, 20b overlying the whisker forming metal at the corners, edges and tip surfaces of the conductive structure 10, whisker induced electrical device failure may be substantially reduced.

The increased concentration of reinforcing particles 20a, 20b at the corner, edges and tip surfaces may be caused by the flow of particles that are suspended in the solvent of the coating composition toward the contact lines between the deposited coating composition and the conductive structure 10 during evaporation of the solvent component of the coating composition. The contact lines represent the border of the liquid coating composition that forms an interface with the conductive structure 10. As depicted in FIG. 5A, the contact lines may be present at the edge surfaces of the conductive structure 10. The solvent component of the coating composition may be evaporated during the curing process that follows deposition of the coating composition for forming the composite coating 15. As the solvent evaporates, the remaining portion of the solvent flows towards the contact lines. Therefore, because the solvent flows towards the contacts lines, the reinforcing o particles 20a, 20b that are dispersed within the solvent is directed towards the contact lines. The flow of the reinforcing particles 20a, 20b to the contact line during evaporation of the solvent may be referred to as “the coffee ring effect”. Although the conductive structure 10 is depicted as having a rectangular geometry, the conductive structure 10 may have any polyhedron shape.

FIG. 5B is a magnified side cross-sectional view of the non-conformal composite coating at a corner surface of the conductive structure 10 that is depicted in FIG. 5A, in which the concentration of the reinforcing particles 20a, 20b is greater at the corner surface of the whisker forming metal than at the face surfaces of the whisker forming metal. In one embodiment, the concentration of reinforcing particles 20a, 20b at the corner surface of the conductive structure 10 may be at least 50% greater than the concentration of reinforcing particles on the remaining surfaces of the conductive structure 10. In another embodiment, the concentration of reinforcing particles 20a, 20b at the corner surface of the conductive structure 10 may be at least 20% greater than the concentration of reinforcing particles on the remaining surfaces of the conductive structure 10.

Still referring to FIG. 5B, in some embodiments, the thickness of the composite coating at the corner, edges and tip surfaces of the conductive structure 10 may be less than the thickness of the composite coating at the remaining surfaces of the conductive structure 10, such as the face surfaces of the conductive structure 10. To increase coverage of the conductive structure 10 with the composite coating, multiple layers of the composite coating may be deposited on the conductive structure 10. Each material layer may include a matrix phase 25a, 25b of a polymer, and a dispersed phase of reinforcing particles 20a, 20b contained within the matrix phase 25a, 25b. In the embodiment that is depicted in FIG. 5B, a first composite coating layer is present in direct contact with an exterior surface of the conductive structure 10, and is composed of a first dispersed phase of first reinforcing particles 20a and a first matrix phase 25a of a polymer. A second composite coating layer is present in direct contact with the exterior surface of the first composite coating layer, wherein the second composite coating layer is composed of a second dispersed phase of second reinforcing particles 20b and a second matrix phase 25b of a polymer. Each material layer of the composite coating may be deposited using the method described above with reference to FIGS. 1-4B. In some embodiments, to increase adhesion between two or more layers of the composite coating, the surface of the last formed composite coating may be treated to reduce its' surface energy prior. For example, the first composite coating layer may be treated with an argon/oxygen plasma or a tetrafluoromethane (CF₄) plasma prior to the deposition of the second composite coating layer.

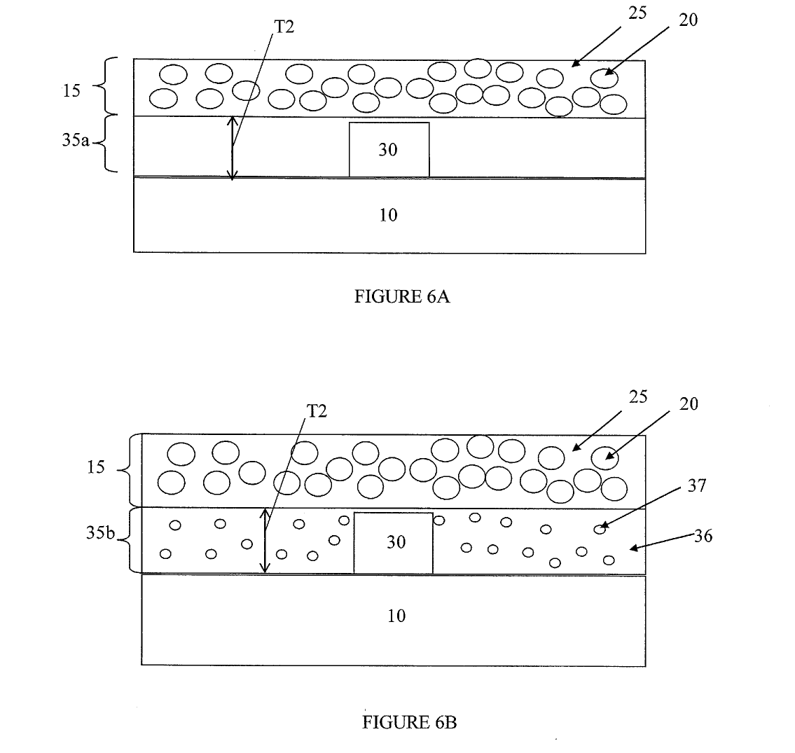

Referring to FIGS. 6A and 6B, in another embodiment, a multi-layered coating is provided that includes at least one composite coating 15 having reinforcing particles 20 and an elastic layer 35a, 35b, wherein the elastic layer 35a, 35b is present between the at least one composite coating 15 and a conductive structure 10. The reinforcing particles 20 are a dispersed phase within a matrix phase of a polymer, wherein the reinforcing particles 20 increase the mechanical properties of the composite coating to obstruct whiskers from penetrating the composite coating 15. The composite coating and its method of forming having been described above with reference to FIGS. 1-4B.

The elastic layer 35a, 35b that separates the composite coating 15 from the conductive structure 10 including the whisker forming metal has a strength, e.g., hardness and fracture toughness, that is less than the composite coating 15. For example, mechanical properties of the elastic layer 35a, 35b is selected to allow for the whisker 30 to penetrate the elastic layer 35a, 35b. The elastic layer 35a, 35b provides the interface between the composite coating 15 and the conductive structure, and may be referred to as an “interface layer”. In one embodiment, the elastic modulus of the elastic layer 35a, 35b may be range from 1.0 MPa to 5.0 MPa. In another embodiment, the elastic layer 35a, 35b may have an elastic modulus ranging from 1.4 MPa to 2.0 MPa.

The thickness of the elastic layer 35a, 35b is selected so that the distance that the whisker 30 would have to grow from upper surface of the conductive structure 10 to contact the lower surface of the composite coating 15 would increase the aspect ratio of the whisker 30 so that the buckling force of the whisker 30 is less than the peel force of the composite coating 15. In one embodiment, the thickness T2 of the elastic layer 35a, 35b ranges from 2 microns to 100 microns. In another embodiment, the thickness T2 of the elastic layer 35a, 35b ranges from 5 microns to 50 microns. In some embodiments, the elastic layer 35a, 35b may also increase the adhesion of the composite coating 15 to the conductive structure 10 including the whisker forming metal.

FIG. 6A depicts a conductive structure 10 composed of a whisker forming metal having a composite coating 15 present thereon, wherein an elastic layer 35a of an unfilled polymer is present between the composite coating 15 and the whisker forming metal. By “unfilled” it is meant that the elastic layer 35a does not include reinforcing particles 10. In one embodiment, the elastic layer 35a is composed of a polymer. Examples of polymers suitable for the elastic layer 35a include urethanes, polyurethanes, acrylics, acrylated urethanes, silicones, epoxies and a combination thereof. Specific examples of materials that are suitable for the elastic layer 35a include polydimethylsiloxane, polyisocyanate, polyole and combinations thereof. The elastic layer 35a may be applied to the surface of the conductive structure 10 using dip coating, spray coating, curtain coating, and brushing.

FIG. 6B depicts a conductive structure 10 composed of a whisker forming metal having a composite coating 15 present thereon, wherein an elastic layer 35b of a reinforced polymer having a higher elasticity than the composite coating 15 is present between the composite coating 15 and the conductive structure 10. The reinforced polymer that provides the elastic layer 35b may be provided by a composite including a matrix phase 37 composed of a polymer and a dispersed phase of a reinforcing particle 36. The polymer that provides the matrix phase 36 and the reinforcing particles 37 of the elastic layer 35b, are similar to the polymer that provides the matrix phase 25 and the reinforcing particles 20 of the composite coating 15. Therefore, the composition and method of forming the composite coating 15 is suitable for the description of the composition and method of forming the elastic layer 35b.

To provide a reduced strength, e.g., reduced hardness and/or reduced rupture force, and increased elasticity in the elastic layer 35b in comparison to the composite coating 15, the concentration, composition and/or particle size of the reinforcing particles 36 is different in the elastic layer 35b than the composite coating 15. In one embodiment, to reduce the mechanical properties of the elastic layer 35b, the concentration of the reinforcing particles 36 may be less than the concentration of the reinforcing particles 20 in the composite coating 15. For example, the concentration of the reinforcing particles 36 in the elastic layer 35b may be at least 20% less than the concentration of the reinforcing particles 20 in the composite coating 15. In another embodiment, to reduce the mechanical properties of the elastic layer 35b, the size of the reinforcing particles 36 may be less than the size of the reinforcing particles 20 in the composite coating 15. For example, the size of the reinforcing particles 36 in the elastic layer 35b may be at least 20% less than the size of the reinforcing particles 20 in the composite coating 15. In some embodiments, to increase adhesion between the elastic layer 35b and the composite coating 15, the surface of the elastic layer 35b may be treated to reduce its' surface energy prior to the deposition of the composite coating 15. For example, the deposition surface of the elastic layer 35b may be treated with an argon/oxygen plasma or a tetrafluoromethane (CF₄) plasma.

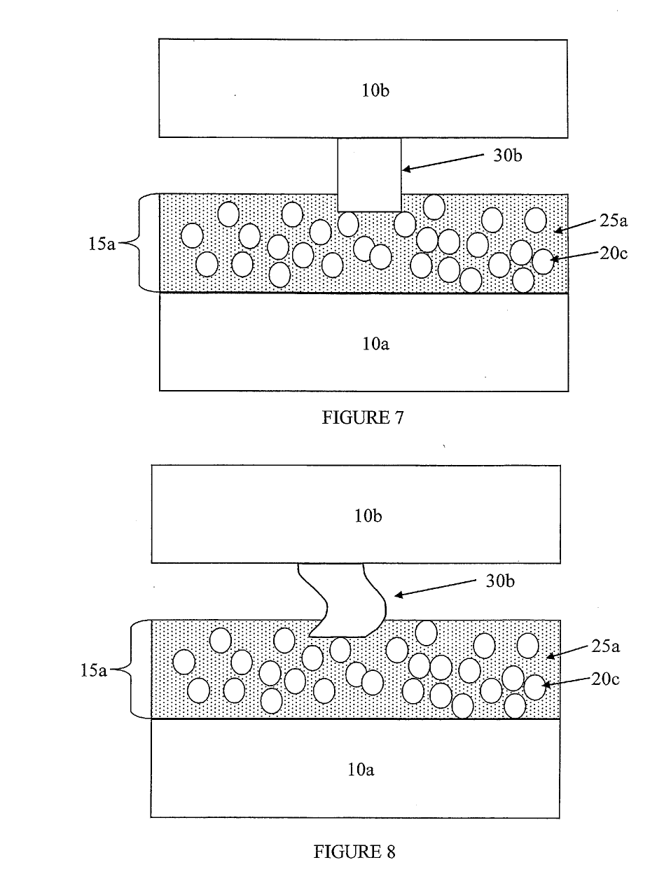

In yet another embodiment, a composite coating 15a may be formed on a conductive structure 10a to protect the conductive structure 10a from being contacted by whiskers 30b that are produced by an adjacent whisker forming material 10b, as illustrated in FIG. 7. The whisker forming material 10b that is depicted in FIG. 7 is similar in composition to the whisker forming metal that has been described above with reference to FIG. 1. The whisker forming material 10b may be present in any structure or geometry, such as a wire, electronic component lead, circuit board, ball grid array package, quad flat package, terminal, busbar, circuit breaker, fuse, contactor, switch, relay or a combination thereof. Other types of structures that are suitable for providing the whisker forming material 10b include metal enclosures, such as those use for electromagnetic shielding or mechanical protection, brackets, heatsinks, connector parts (shells, contacts or mechanical structural elements), and fasteners or a combination thereof. The whisker 30b depicted in FIG. 7 that is produced by the whisker forming material 10b is similar to the whisker 30 that is described above with reference to FIGS. 1-4B. Therefore, the description of the whisker 30 that is depicted in FIGS. 1-4B is suitable for the whisker 30b that is depicted in FIG. 7.

The composite coating 15a may be present on at least the surfaces of the conductive structure 10a that may be contacted by the whisker 30b that is produced by the whisker forming material 10b. In some embodiments, the composite coating 15a includes reinforcing particles 20c that increases the mechanical properties of the composite coating 15a in order to obstruct whisker 30 from penetrating the composite coating 15. By encapsulating the conductive structure 10a with the composite coating 15a, the whiskers 30b that are produced by the whisker forming material 10b are obstructed from shorting to the conductive structure 10a. The reinforcing particles 20c and the matrix 25a of the composite coating 15 that is present on the conductive structure 10a are similar to the reinforcing particles 20 and the matrix 25 of the composite coating 15 that is depicted in FIGS. 1-4B. Therefore, the description of the composite coating 15 including the reinforcing particles 20 and the matrix 25 that is depicted in FIGS. 1-4B is suitable for reinforcing particles 20c and the matrix 25a of the composite coating 15a that is depicted in FIG. 7. The conductive structure 10a that is coating with the composite coating 15a is similar to the conductive structure 10 that is depicted in FIGS. 1-4B. For example, in some embodiments, the conductive structure 10a may be any structure or geometry, such as a wire, electronic component lead, circuit board, ball grid array package, quad flat package, terminal, busbar, circuit breaker, fuse, contactor, switch, relay or a combination thereof. FIG. 8 depicts buckling of the whisker 30b growing from the whisker forming material 10b, wherein the buckling force of the whisker 30 is less than the rupture force of the composite coating 15a.

While the methods and structures of the present disclosure have been particularly shown and described with respect to preferred embodiments thereof, it will be understood by those skilled in the art that the foregoing and other changes in forms and details may be made without departing from the spirit and scope of the claims. It is therefore intended that the present disclosure not be limited to the exact forms and details described and illustrated, but fall within the scope of the appended claims.

Having thus described our invention in detail, what we claim as new and desire to secure by the Letters Patent is:

1. A conductive structure comprising:
a whisker forming metal; and
a composite coating comprising a matrix phase of a polymer and a dispersed phase of reinforcing particles, the composite coating encapsulating the whisker forming metal, wherein at least the reinforcing particles within the matrix phase of the polymer provides the composite coating with mechanical properties that obstruct whiskers produced by the whisker forming metal from protruding through the composite coating.

2. The conductive structure of claim 1, wherein the whisker forming metal is a metal that is selected from the group consisting of tin (Sn), zinc (Zn), silver (Ag), gold (Au), cadmium (Cd), aluminum (Al), lead (Pb), indium (In) and alloys thereof.

3. The conductive structure of claim 1, wherein the whisker forming metal is the base material of a metal wire, enclosure, plate, bracket, heatsink, connector part, electronic component lead, terminal, wire, busbar, circuit breaker, fuse, contactor, switch, relay and fastener a combination thereof.

4. The conductive structure of claim 1, wherein the polymer of the matrix phase comprises polyurethane, acrylic, epoxy, silicone or a combination thereof.

5. The conductive structure of claim 1, wherein the reinforcing particles are present in the composite coating in a concentration ranging from 5 percent by weight to 30 percent by weight.

6. The conductive structure of claim 1, wherein the reinforcing particles have a composition selected from the group consisting of silicon oxide (SiO₂), aluminum oxide (Al₂O₃), silicon nitride (Si₃N₄), silicon carbide (SiC), and magnesium oxide (MgO).

7. The conductive structure of claim 1, wherein the reinforcing particles have a geometry selected from the group consisting of sphere, rod, fiber, plate or combinations thereof.

8. The conductive structure of claim 1, wherein the reinforcing particles are nano-particles having a greatest axis with a dimension ranging from 5 nm to 1000 nm, or the reinforcing particles are micro-particles with a dimension ranging from 1 micron to 10 microns and combinations thereof.

9. The conductive structure of claim 1, wherein the whisker forming metal is separated from the composite coating by an interface layer having a higher elasticity than the composite coating, wherein the interface layer is a material layer that does not include said reinforcing particles.

10. The conductive structure of claim 1, wherein the whisker forming metal is separated from the composite coating by an interface layer having a higher elasticity than the composite coating, wherein the interface layer is a material layer that includes said reinforcing particles in lesser concentration than the composite coating.

11. The conductive structure of claim 1, wherein the composite coating has a rupture force that is greater than the buckle force of a whisker produced by the composite coating.

12. The conductive structure of claim 1, wherein the whisker forming metal has a polyhedron geometry shape, and a concentration of the reinforcing particles in the composite coating is greater at corner surfaces of said polyhedron geometry shape than at face surfaces of said polyhedron geometry shape.

13. The conductive structure of claim 1, wherein a hardness of the composite coating ranges from 25 Shore A to 100 Shore D.

14. A method of obstructing metal whisker growth comprising:
providing a conductive structure comprised of a whisker forming metal; and
forming a composite coating on the whisker forming metal, the composite coating comprising a matrix phase of a polymer and a dispersed phase of reinforcing particles, wherein the reinforcing particles are incorporated into the polymer to obstruct whiskers produced by the whisker forming metal from penetrating through the composite coating.

15. The method of claim 14, wherein the whisker forming metal is a metal that is selected from the group consisting of tin (Sn), zinc (Zn), silver (Ag), gold (Au), cadmium (Cd), aluminum (Al), lead (Pb), indium (In), and alloys thereof.

16. The method of claim 14, wherein the forming of the composite coating comprises:
mixing the polymer and the reinforcing particles to provide a coating composition; and
depositing the coating composition on the whisker forming metal to form the composite coating with a process selected from the group consisting of spraying, dip coating, brushing and curtain coating.

17. The method of claim 14, wherein the reinforcing particles comprise 5% to 20% of the coating composition by volume.

18. The method of claim 14, further comprising forming an interface layer on the whisker forming metal before said forming of the composite coating on the conductive structure, wherein the interface layer has a greater elasticity than the composite coating.

19. The method of claim 18, wherein the interface layer is a material layer that does not include said reinforcing particles or includes said reinforcing particles in lesser concentration than the composite coating.

20. The method of claim 18, wherein the conductive structure including the whisker forming metal has a polyhedron geometry shape, and a concentration of the reinforcing particles in the composite coating is greater at corner surfaces of said polyhedron geometry shape than at face surfaces of said polyhedron geometry shape.

21. The method of claim 20, wherein an increased concentration of reinforcing particles at said corner surfaces is provided by diffusion of the reinforcing particles from a deposited coating composition during evaporation of solvent from the coating composition during the forming of the composite coating on the whisker forming metal.

22. The method of claim 14, wherein a peel force of the composite coating ranges from 0.2 to 200 micro-newtons per micron.

23. The method of claim 14, wherein a buckle force of the whisker ranges from 2 to 500 micro-newtons.

24. A method of obstructing electrical shorting comprising:
providing a conductive structure adjacent to a whisker forming material; and
forming a composite coating on the conductive structure, the composite coating comprising a matrix phase of a polymer and a dispersed phase of reinforcing particles, wherein the reinforcing particles are incorporated into the polymer to obstruct whiskers produced by the whisker forming metal from penetrating through the composite coating into contact with the conductive structure.

25. The method of claim 24, wherein the polymer of the matrix phase comprises polyurethane, acrylic, epoxy, silicone or a combination thereof, and the reinforcing particles have a composition selected from the group consisting of silicon oxide (SiO₂), aluminum oxide (Al₂O₃), silicon nitride (Si₃N₄), silicon carbide (SiC), magnesium oxide (MgO) and a combination thereof.

26. The method of claim 24, wherein the whisker forming material is a metal that is selected from the group consisting of tin (Sn), zinc (Zn), silver (Ag), gold (Au), cadmium (Cd), aluminum (Al), lead (Pb), indium (In), and alloys thereof, and the conductive structure is selected from the group consisting of a metal wire, enclosure, plate, bracket, heatsink, connector part, electronic component lead, terminal, wire, busbar, circuit breaker, fuse, contactor, switch, relay, fastener or a combination thereof.

27. A conductive structure comprising:
a conductive metal;
a whisker forming material adjacent to the conductive metal; and
a composite coating on the conductive metal, the composite coating comprising a matrix phase of a polymer and a dispersed phase of reinforcing particles having a hardness ranging from 25 Shore A to 100 Shore D, wherein at least the reinforcing particles within the matrix phase of the polymer provides said composite coating with a mechanical strength that obstructs whiskers produced by the adjacent whisker forming material from protruding through the composite coating and shorting the conductive metal to the whisker forming material.

28. The conductive structure of claim 27, wherein the conductive metal may be provided by a structure having a geometry of a wire, enclosure, plate, bracket, heatsink, connector part, electronic component lead, terminal, wire, busbar, circuit breaker, fuse, contactor, switch, relay, fastener or a combination thereof.

29. The conductive structure of claim 27, wherein the whisker forming material is a metal that is selected from the group consisting of tin (Sn), zinc (Zn), silver (Ag), gold (Au), cadmium (Cd), aluminum (Al), lead (Pb), indium (In) and a combination thereof, and the whisker forming material has a geometry of a wire, enclosure, plate, bracket, heatsink, connector part, electronic component lead, terminal, wire, busbar, circuit breaker, fuse, contactor, switch, relay, fastener or a combination thereof.

30. The conductive structure of claim 27, wherein the polymer of the matrix phase comprises polyurethane, acrylic, epoxy, silicone or a combination thereof, and the reinforcing particles have a composition selected from the group consisting of silicon oxide (SiO₂), aluminum oxide (Al₂O₃), silicon nitride (Si₃N₄), silicon carbide (SiC), magnesium oxide (MgO) and a combination thereof.
